(19) United States
(12) Patent Application Publication
(10) Pub. No.: US 2006/0095715 A1
(43) Pub. Date: May 4, 2006

(54) Very long instruction word processor

(75) Inventors: Balakrishnan Srinivasan, Eindhoven (NL); Ramanathan Sethuraman, Eindhoven (NL); Carlos Antonio Alba Pinto, Eindhoven (NL); Harm Johannes Antonious Maria Peters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/540,698

(22) PCT Filed: Dec. 3, 2003
(86) PCT No.: PCT/IB03/05695

§ 371 Date: Jun. 24, 2005

(30) Foreign Application Priority Data
Dec. 30, 2002 (EP) 02080599.0

(51) Int. Cl. G06F 15/00

(52) U.S. Cl. 712/24

(57) ABSTRACT

The invention relates to a very long instruction word (VLIW) processor comprising a plurality of functional units (110, 130, 135), each for executing an operation, and a VLIW controller (100) connected to each of said functional units (110, 130, 135) and adapted to controlling said functional units (110, 130, 135). The VLIW processor comprises at least one indication means (140) associated with one of said functional units (135) and adapted to registering and indicating to the VLIW controller (100) whether said one functional unit (135) is idle or operating.

The present invention relates to a very long instruction word (VLIW) processor according to the preamble of appended claim 1.

VLIW processors may be used in a variety of applications ranging from super computers to work stations and personal computers. They may be used as dedicated or programmable processors in work stations, personal computers and video or audio consumer products. They may be application specific processors, i.e. they may be designed to process specific applications in order to enhance the performance of these applications. To this end special functional units are incorporated in the VLIW processor. Each functional unit is designed to process a particular operation depending on the application to be processed. A VLIW controller is connected to each of these functional units in order to control the operating sequence of the functional units. The VLIW controller has to issue the operations performed by the functional units. The set of instructions to be executed by the VLIW processor contains the scheduled operations.

While a functional unit is performing an operation, further operations may not be scheduled on said functional unit if the functional unit is un-pipelined. A new operation can be scheduled by the compiler after a fixed number of cycles corresponding to the initiation interval of the functional unit if it is pipelined. After a functional unit has finished processing, the processing results must be further processed or output from the VLIW processor. The compiler generating the set of instructions needs to know the initiation interval and latency of the functional units at compile time in order to schedule the operations of these units. The initiation interval of a functional unit is the time interval after which a new operation can be initiated on it. The latency of a functional unit is the time it takes for the functional unit to perform its operation. The operations mapped on the functional units sometimes have latencies of the order of 10 to 1000 clock cycles. Further, the latency of the functional unit may be variable. Conventionally, techniques for determining the latency of operations at compile time are used. However, input data dependent latencies cannot be calculated at compile time. Previously, these operations were scheduled assuming a worst-case initiation interval and latency. The worst-case initiation interval is the minimum time interval after which a new operation can be initiated on the functional unit without altering the order in which the outputs arrive. The worst case latency is the maximum time for the functional unit to perform its operation.

The use of worst-case latencies for scheduling the operations of functional units in a VLIW processor has several drawbacks. Either a large decision tree needs to be scheduled in parallel to fill up other issue slots or the compiler has to introduce no-ops (no operation instructions) in the schedule. Poor schedules result in a bad performance of the application processing and leads to larger power consumption.

It is an object of the present invention to improve the performance and power consumption of VLIW processors.

This object is achieved by a VLIW processor and processing method as claimed in claims 1 and 11, respectively.

Accordingly, an indication means is provided which is associated with one functional unit. Preferably the indication means is associated with a functional unit having a variable, data dependent latency. The indication means is adapted to register whether the functional unit is idle or operating. This is indicated to the VLIW controller. Therefore the latency need not be predicted at compile time in order to issue the operations. During the operation the state of the functional unit is reported to the VLIW controller. If the functional unit has finished its operation, the VLIW controller may immediately issue further operations on the functional unit. Thereby no-ops may be avoided. The speed of the application is enhanced.

The VLIW processor according to the present invention may comprise several functional units having variable long latencies. Each of the functional units having variable long latencies may be associated with an indication means that reports the state of the functional unit to the VLIW controller as described in the previous paragraph.

If the VLIW processor must not perform further operations during the operation on the functional unit, the remaining functional units of the processor may rest. Accordingly, power consumption may be reduced even further. The VLIW may be brought into processor-stalling state for long latency operations or only part of the processor may be stalled depending on whether any useful operations can be issued in the other issue slots.

Preferably the indication means is adapted to register whether said one functional unit receives data for executing the operation and whether said one functional unit outputs data after executing the operation. This is a very simple and effective way of determining whether the functional unit is operating or not. Whenever the functional unit receives data to be processed, the functional unit changes from an idle state to a busy state. The completion of the operation is evidenced by the writing of the result of the operation into a destination register. Therefore the state of the functional unit may be determined by monitoring the input and/or output of data.

The indication means may comprise an input register for inputting data to said one functional unit and an output register for receiving data output from said one functional unit. The input and output registers each comprise a presence bit indicative of the presence or absence of data in the respective register. Initially the input and output registers are set to an empty state. Whenever data is written into one of the registers, the presence bit indicates the presence of data. Whenever data is output from one of the registers, the presence bit indicates the absence of data. The presence bit of a set of input registers indicate that the functional unit can begin an operation. The subsequent indication of data in the output register indicates the termination of the operation. A single memory operation can read both the data and synchronization information. A separate hardware device need not be provided for determining synchronization information. The presence bit amounts to a hardware overhead of only one bit per word.

Preferably the input register is adapted to trigger the execution of the operation by said one functional unit depending on the presence of data in the input register. The input register initiates the operation on the availability of data. The VLIW controller is relieved of separately triggering the operation of the functional unit. The input of data to the register ensures simultaneously that the functional unit receives the data to be processed and immediately starts to process the data when available. In addition, if the functional unit can execute more than one function/instruction, a VLIW processor can issue a special command for setting said function/instruction even before input data is available. This means that the input/output time shapes will depend on the command.

The indication means may comprise an input register file containing a plurality of said input registers and an output register file containing a plurality of said output registers. Each input register and each output register contains a presence bit. A whole set of words can be provided to the input register file. Thereby the VLIW controller does not have to provide for new data once the functional unit has processed the data word contained in one input register. The functional unit may either execute an operation when all data arrives in the input register file or can start execution when there is sufficient number of inputs to proceed with a part of the computation. The triggering of the functional unit may depend suitably on the number of input register presence bits indicating the presence of data. The register files may be FIFOs (First-In-First-Out) or stacks or a combination of them, as disclosed by B. Mesman: Constraint Analysis for DSP Code Generation, PhD thesis, Eindhoven University of Technology, The Netherlands, May 2001. The order in which data is provided to and from the input and output register files may be defined by an access ordering method, as disclosed by C. Alba Pinto: Storage Constraint Satisfaction for embedded Processor Compilers, Ph.D thesis. Eindhoven University of Technology, The Netherlands, June 2002. As a consequence the VLIW controller needs lesser control bits to control the functional unit.

If the same input data is to be used several times by the functional unit, a temporary register may be provided in the VLIW processor. The temporary register is connected to the functional unit, in order to store data to be used repeatedly by said one functional unit. A normal register file may also be used as a temporary register.

If the VLIW processor comprises a second functional unit which is adapted to execute an operation on the data output from said one functional unit, the indication means may be connected to the second functional unit in order to indicate whether said one functional unit is outputting data. Thereby the operation of the second functional unit may be triggered by the indication means in the event, that the required data is output from the functional unit associated with the indication means. The control of the second functional unit may be performed by the indication means. As a consequence the VLIW controller is relieved of the task of triggering the second functional unit.

An embodiment of the present invention will be described with reference to the accompanied drawings.

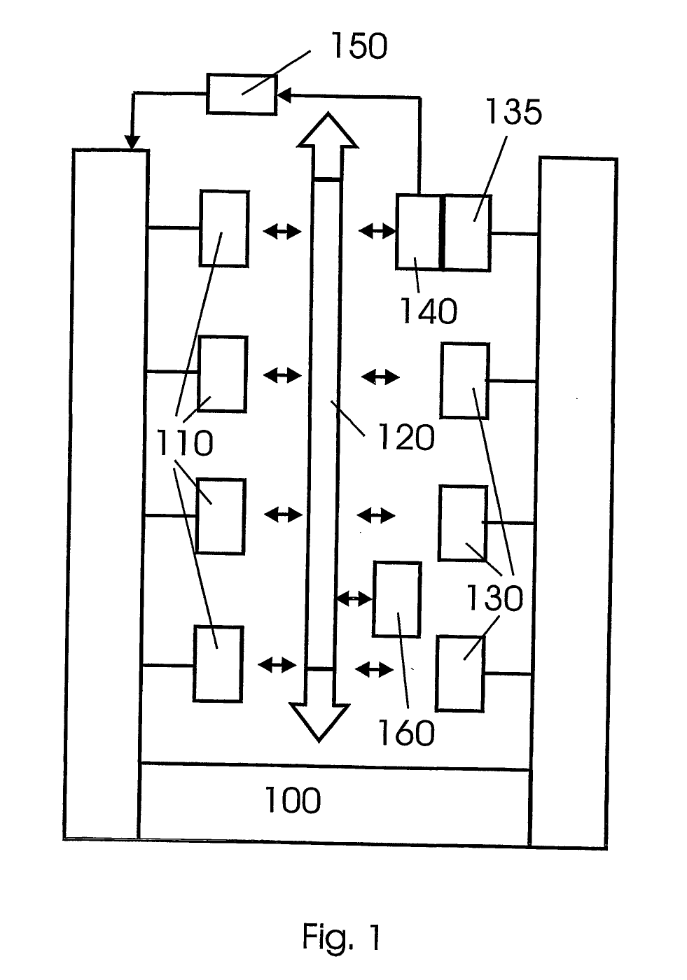

FIG. 1 shows a VLIW processor according to an embodiment of the present invention.

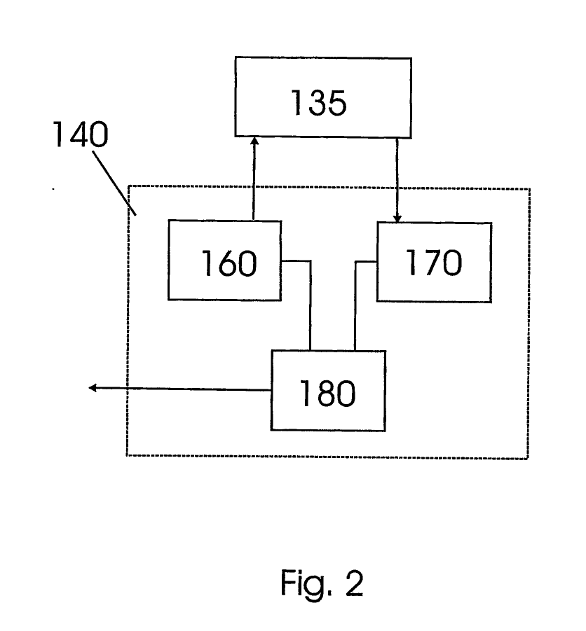

FIG. 2 shows in more detail the indication means 140 associated with the application specific unit 135.

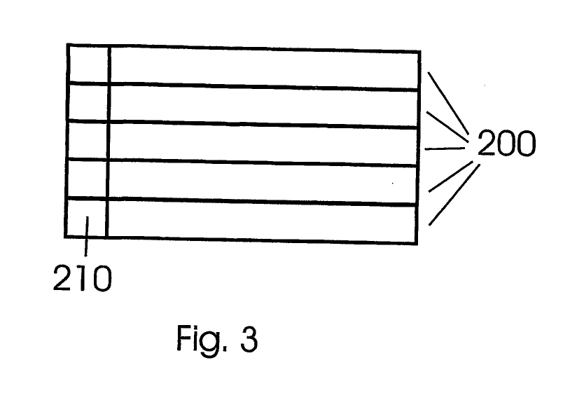

FIG. 3 shows the structure of both register files 160 and 170.

FIG. 1 depicts the VLIW processor according to the embodiment of the present invention. The VLIW processor comprises a VLIW controller 100 that is connected to a number of functional units 110, 130 and 135. The VLIW controller 100 issues in particular the operation of the functional units 110, 130 and 135. An interconnection network 120 connects the functional units 110, 130 and 135 directly in order to facilitate data transfer between these functional units. A global register file 160 stores values produced by the functional units 110, 130 and 135. The purpose of the global register files is to provide a way of communicating data produced by one of the functional units 110, 130, 135 to the other functional units 110, 130 and 135. Reference sign 110 depicts standard VLIW functional units. The units 110 may encompass standard arithmetic and logical units (ALUs), a constant generating unit (CONST), a memory unit (MEM) for data and an instruction memory (INSTR MEM). These units may be used in a large number of applications.

The functional units 130 and 135 are application specific units (ASUs). They are designed to perform specific operations geared to a particular application. An example for such an application is a hybrid encoder with embedded compression as described in Kleihorst R. P., and R. J. van der Vleuten, DCT-domain embedded memory compression for hybrid video coders, Journal of VLSI signal processing systems, Vol. 24, page 31-41, 2000. Such an application calls for a number of ASUs, such as a discrete cosine transform (DCT) for data transformation and inverse discrete cosine transform (IDCT) for data inverse-transformation as well as encoder and decoder units (ENC and DEC) for performing bit-plane by bit-plane encoding and decoding of DCT coefficients. The ENC and DEC units can have processing times between 64 and 128 clock cycles depending on the input data. Reference sign 135 shows an ASU having a variable long latency behavior.

In order to schedule the operation of the ASU 135 an indicator means 140 is provided. The indicator means 140 detects the state of the ASU 135. In case the ASU is executing an operation, the indicator means 140 sends a signal to a hold control unit 150. Hereupon the unit 150 generates a hold signal which is transferred to the VLIW Controller 100. The VLIW controller 100 halts the rest of the VLIW processor as long as the hold signal is received. This means that the ASU 135 performs its operation, while the rest of the VLIW processor remains unchanged when it attempts to read an output produced by the ASU 135. The hold operation leads to a reduction of the power consumption of the VLIW processor during the latency of the ASU 135. Once the variable latency ASU 135 is ready with the required output, the hold signal is reset by the indicator means 140. Hereupon the rest of the processor is reactivated and consumes the output of the ASU 135. The processing speed is optimized since the VLIW processor continues processing the application in due time.

FIG. 2 shows in greater detail the structure of the indication means 140 associated with the ASU 135 having a variable latency. The indicator means comprises two register files 160 and 170. Data to be processed is input in ASU 135 via the input register file 160. The result of processing the data is output to the output register file 170. The indication means further comprises a detection unit 180 connected to the register files 160 and 170. The detection unit 180 detects whether data is output from the register file to the ASU 135 and whether data is received from the ASU 135 in register file 170. As soon as the detection unit 180 detects the input of data in the ASU 135, the detection unit 180 generates a signal to the hold unit. The detection unit 180 stops sending the signal to the hold unit once it detects the output of data from the ASU 135.

FIG. 3 shows schematically the structure of both register files 160 and 170 being identical. The register file contains a number of registers 200. Each register contains a presence bit 210. All the registers are initialized to the empty state. Whenever data is read into one register the corresponding presence bit 210 changes its state in order to indicate the presence of a data word. The output of data from a register has the effect that the register becomes empty and the presence bit changes its state. The output of data from the input register to the ASU is triggered by the availability of input data. This means that the input register file instructs the ASU to start computation when a single or a predetermined number of presence bits indicate the presence of input data. Simultaneously the initialization of an operation is reported to the detection unit 180.

1. A VLIW processor comprising
a plurality of functional units, each for executing an operation, and a VLIW controller connected to each of said functional units and adapted to control said functional units characterized by
at least one indication means associated with one of said functional units and adapted to register and indicate to the VLIW controller whether said one functional unit is idle or operating.

2. The VLIW processor of claim 1,
wherein said indication means is adapted to register whether said one functional unit receives data for executing its operation and whether said one functional unit outputs data after executing its operation.

3. The VLIW processor of claim 2,
wherein said indication means comprises an input register for inputting data to said one functional unit and an output register for receiving data output from said one functional unit, said input and output register each comprising a presence bit indicative of the presence or absence of data in the respective register.

4. The VLIW processor of claim 3,
wherein said input register is adapted to trigger the execution of the operation by said one functional unit, if data is present in the input register.

5. The VLIW processor of claim 3,
wherein said indication means comprises an input register file having a plurality of said input registers and an output register file having a plurality of said output registers.

6. The VLIW processor of claim 5,
wherein the input register file is adapted to trigger the execution of the operation by said one functional unit, if a predetermined number of the input registers contain data.

7. The VLIW processor of claim 2, comprising a temporary register for storing data to be used repeatedly by said one functional unit, said temporary register being connected to said one functional unit.

8. The VLIW processor of claim 5,
wherein the output register file is adapted to trigger the execution of the operation of a second functional unit, if a predetermined number of output registers contain data.

9. The VLIW processor of claim 1,
wherein said one functional unit has a variable long latency.

10. The VLIW processor of claim 1,
wherein the latency of the one functional unit depends on the data to be processed by said functional unit.

11. Method of processing data in a VLIW processor, comprising the steps:
registering whether a functional unit is idle or operating; and
indicating to said VLIW controller whether said functional unit is idle or operating.

12. The method of claim 11,
wherein said registering step comprises the steps registering whether said one functional unit receives data for executing its operation and whether said one functional unit outputs data after executing its operation.

13. The method of claim 12,
comprising the steps of
indicating to the VLIW controller that the functional unit receives data, and
indicating to the VLIW controller that the functional unit outputs data.
